(19) United States
(12) Patent Application Publication
(10) Pub. No.: US 2017/0249057 A1
(43) Pub. Date: Aug. 31, 2017

(54) EXECUTABLE CODE IN A MEDIA FILE

(71) Applicant: HEWLETT PACKARD ENTERPRISE DEVELOPMENT LP, Houston, TX (US)

(72) Inventors: Michael AARON, Yehud (IL); Eli REVACH, Yehud (IL); Amos NESHER, Yehud (IL)

(73) Assignee: HEWLETT PACKARD ENTERPRISE DEVELOPMENT LP, Houston, TX (US)

(21) Appl. No.: 15/500,038

(22) PCT Filed: Sep. 30, 2014
(86) PCT No.: PCT/US2014/058172

§ 371 Date: Jan. 28, 2017

(51) Int. Cl. G06F 3/0481; G06F 3/0484; G06F 9/44

(52) U.S. Cl. CPC G06F 3/0481; G06F 9/4421; G06F 3/04847

(57) ABSTRACT

Examples disclosed herein provide executable code within a media file. One example method includes identifying, via a processor, a media file that is to include executable code; and inserting, via the processor, the executable code into a track of the media file, the executable code to be executed upon playback of media within the media file and, when executed, the executable code is to cause control of an environment of a host device playing back the media.

### BACKGROUND

Media files include media (e.g., video, audio, text, images, etc.) along with metadata (e.g., subtitles, time information, location information, formatting information, etc.). An example media file (e.g., a video file, audio file, etc.) may include a plurality of tracks (e.g., layers, etc.) to include various types of media or information within the media file. For example, a video file may include a track for video content, audio content, subtitle content, image content, etc. Accordingly, the content of the tracks in a media file may be presented via a host device (e.g., a computer, a mobile device (a smartphone, tablet computer, mp3 player, etc.), a disc player (e.g., DVD player, Blu-ray player), a set top box, a game console, etc.) based on timing or locations of the content within the tracks of the media file.

### BRIEF DESCRIPTION OF THE DRAWINGS

FIG. 1 illustrates a schematic diagram of an example media system including a code enabled media generator constructed in accordance with an aspect of this disclosure and a host device including a code enabled media player constructed in accordance with an aspect of this disclosure.

FIG. 2 a block diagram of an example code enabled media generator that may be used to implement the code enabled media generator of FIG. 1.

FIG. 3 is a diagram of an example code enabled media file including executable code that may be generated by the example code enabled media generator of FIG. 1 or 2.

FIG. 4 is a block diagram of an example code enabled media player that may be used to implement the code enabled media player of FIG. 1 or facilitate presentation/execution the example code enabled media file of FIG. 3.

FIGS. 5A-5D illustrate example executions of a code enabled media file, such as the code enabled media file of FIG. 3, when accessed via the code enabled media player of FIG. 1 or 4.

FIG. 6 is a flowchart representative of example machine readable instructions that may be executed to implement the code enabled media generator of FIG. 2.

FIG. 7 is a flowchart representative of an example portion of the machine readable instructions of FIG. 6 that may be executed to implement the code enabled media generator of FIG. 2.

FIG. 8 is a flowchart representative of other example machine readable instructions that may be executed to implement the code enabled media player of FIG. 4.

FIG. 9 is a flowchart representative of an example portion of the machine readable instructions of FIG. 8 that may be executed to implement the code enabled media player of FIG. 4.

FIG. 10 is a block diagram of an example processor platform capable of executing the instructions of FIG. 6 or 7 to implement the code enabled media generator 110 of FIG. 2 or the instructions of FIG. 8 or 9 to implement the code enabled media player 122 of FIG. 4.

Wherever possible, the same or similar reference numbers will be used throughout the drawing(s) and accompanying written description to refer to the same or like elements.

### DETAILED DESCRIPTION

Examples disclosed herein involve including executable code within media. In examples disclosed herein, executable code may be included in a track of a media file such that the executable code is executed to control an environment of played back media of the media file. Furthermore, examples disclosed herein involve identifying executable code within a media file and executing the executable code to control a media player or an environment (e.g., an operating system, peripheral devices, a browser, an application, etc.) associated with the media playback.

Digital media provides for playback of media on computing devices such as computers (e.g., desktop, laptop, tablet, etc.), mobile devices (e.g., smartphones, tablets, etc.) or set top boxes (e.g., digital video recorders, game consoles, etc.). Examples disclosed herein provide for an enhanced user experience by including executable code to control features or environments of host devices that may complement or correspond to events occurring within the played back media. For example, execution of executable code within a media file may provide for: playback of a video to be adjusted by the executable code based on an input received via the host device from the user, a peripheral device (e.g., a vibration mechanism) to be controlled in response to a particular event occurring within media being played back, or an application/browser to be opened by the host device or navigated in accordance with a corresponding teaching video being presented by the host device. Many other example implementations may enhance the user experience by enabling media files to include executable code or executing the executable code during playback of media in the media files.

An example method includes identifying a media file that is to include executable code, and inserting the executable code into a track of the media file, the executable code to be executed upon playback of media within the media file and, when executed, the executable code is to cause control of a host device playing back the media. Another example method disclosed herein includes identifying executable code within the media file, the media file comprising media being played back by a host device; and executing, via a processor, the executable code to control an environment of the host device.

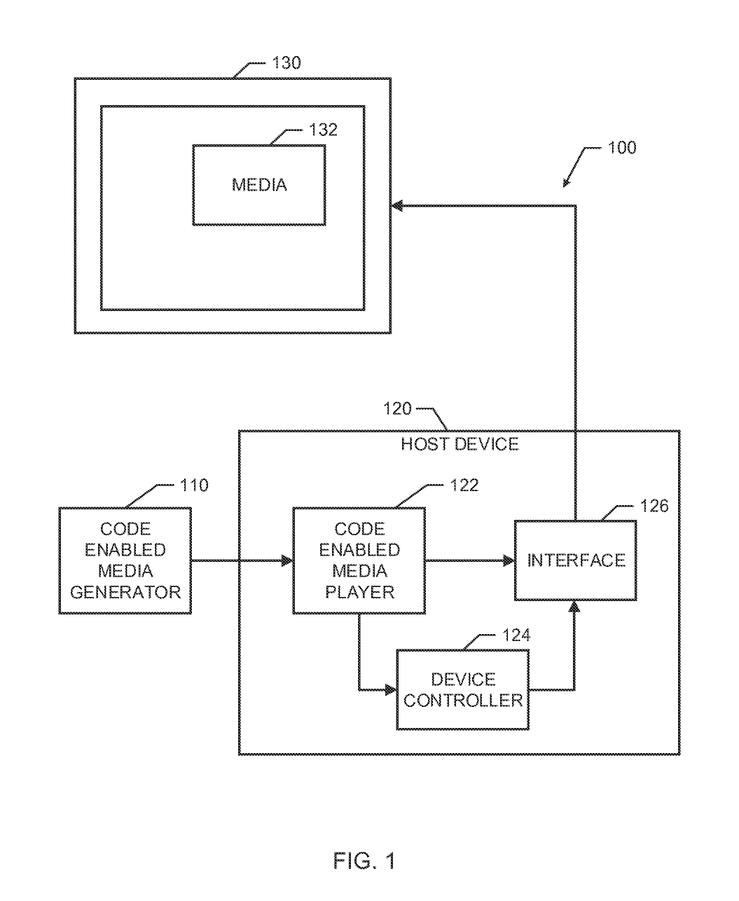

FIG. 1 is a schematic illustration of an example media system 100 including a code enabled media generator 110 implemented in accordance with an aspect of this disclosure and a host device 120 including a code enable media player 122 constructed in accordance with an aspect of this disclosure. The host device 120 (e.g., a computer, a tablet computer, a smartphone, a laptop computer, a set top box, a game console, etc.) in the illustrated example of FIG. 1 communicates with an output device 130 (e.g., a liquid crystal display (LCD), a light emitting diode (LED) display, a speaker, etc.) to output media 132 (e.g., for user exposure or user access). Examples disclosed herein enable inclusion of executable code within the media 132 or executing the executable code during presentation of the media 132 to enhance a user's ability to interact with the media 132, the host device 120, or a user interface/applications running on the host device 120.

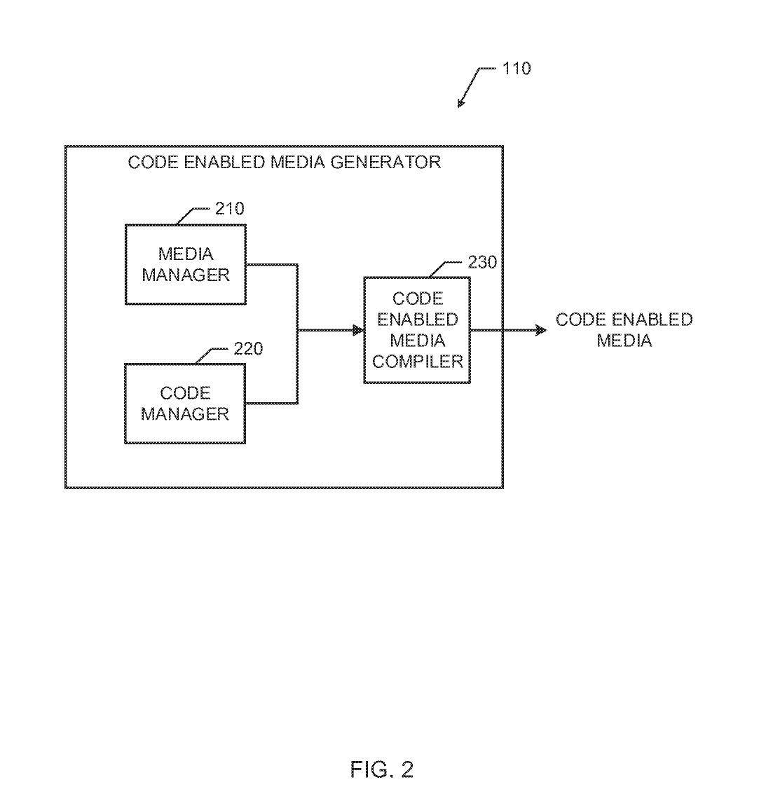

In the illustrated example of FIG. 1, the example code enabled media generator 110 generates media (e.g., the media 132) to include executable code to be executed during presentation of the media. In examples disclosed herein, the executable code may include any code, executable instructions, etc. in any programming language (e.g., Javascript, Linux Shell, PowerShell, Batch files, etc.) supported by the host device 120 (e.g., to call an external library of application programming interfaces (APIs)). The example code enabled media generator 110 of FIG. 1 may be any type of media creator (e.g., a program, an application, etc.) that facilitates creating, editing, or compiling media (e.g., the media 132). In some examples, the code enabled media generator 110 may be located within the host device 120 (e.g., on a storage medium of the host device 120). An example implementation of the code enabled media creator 110 of FIG. 1 is disclosed below in connection with FIG. 2.

The example host device 120 of FIG. 1 includes an example code enabled media player 122, a device controller 124, and an interface 126. In the illustrated example of FIG. 1, the code enabled media player 122 may communicate with the device controller 124 or the interface 126. For example, the code enabled media player 122 may send instructions to the device controller 124 based on executable code within the media 132 (e.g., instructions to execute the code). The device controller 124 may be any control device of the host device 120, such as a processor or central processing unit (CPU) executing instructions to control the host device 120. For example, the device controller 124 may control an operating system (OS) or instructions executing within the operating system (e.g., software, applications, etc.). Furthermore, the device controller 124 may control communications or output from the host device 120 via the interface 126. The example interface 126 may be any interface circuit (e.g., a universal serial bus (USB), a graphics card, an Ethernet interface, a peripheral component interconnect (PCI), etc.). Accordingly, the interface 126 of the host device 120 may facilitate presentation of the media 132 on the display 130 according to instructions from the code enabled media player 122 or the device controller 124. For example, when the media 132 includes executable code in accordance with the teachings of this disclosure, the code enabled media player 122 may provide the media 132 (e.g., a video) to the interface 126 and the device controller 124 may provide display information corresponding to control operations of the host device 120 in response to executing the executable code of the media 132. In some examples, the interface 126 may facilitate communication or control of peripheral devices, such as vibration mechanisms, sensors, cameras, light emitters (e.g., LEDs), flashes, buttons, touchscreens, etc. of the host device 120. Accordingly, executable code in a media file may be executed to control the peripheral devices of the host device 120 or peripheral devices in communication with the host device 120. In some examples, the host device 120 may include the display device 130 (e.g., the display device 130 may be a touchscreen of a smartphone or tablet computer, the display device 130 may be a monitor of the host device 120, etc.).

Accordingly, the media system 100 of FIG. 1 provides for inclusion of executable code within a media file via the code enabled media generator 110 and execution of the executable code when presenting media (e.g., the media 132) via the code enabled media player 122 or the device controller 124 of the host device 120.

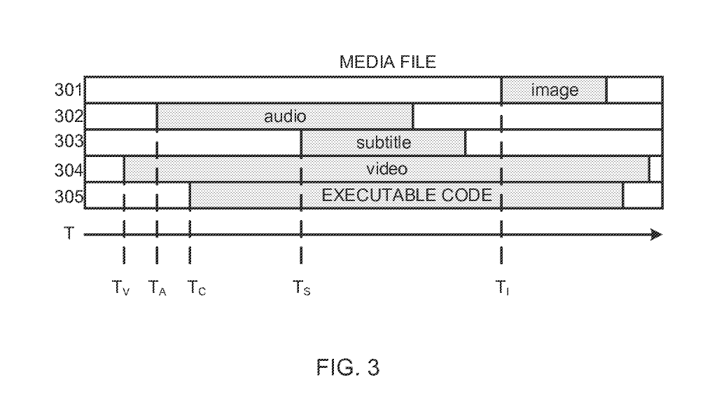

FIG. 2 is a block diagram of an example code enabled media generator 110 that may be used to implement the code enabled media generator 110 of FIG. 1. The code enabled media generator 110 of the illustrated example of FIG. 2 includes a media manager 210, a code manager 220, and a code enabled media compiler 230. In the illustrated example of FIG. 2, the media manager 210 and the code manager 220 provide data to the code enabled media compiler 230 to create a code enabled media file (see FIG. 3).

The example media manager 210 of FIG. 2 manages media or media metadata to be included in a media file generated by the code enabled media generator 110 of FIG. 2. For example, the media manager 210 may facilitate retrieval or importing of media files (e.g., from a database) and corresponding metadata to he included in a code enabled media file composition. The example media manager 210 may further facilitate editing of media files to be included in a code enabled media file generated by the code enable media generator 110 of FIG. 2. For example the media manager 210 may serve as an interface to cut, splice, crop, or edit media (e.g., video files, audio files, images, documents, text, etc.). Accordingly, the media manager 210 may be used to manage media files to be included within a code enabled media file or their corresponding locations within the code enabled media file.

The example code manager 220 of FIG. 2 manages executable code that is to be included in a media file generated by the code enabled media generator 110 of FIG. 2. For example, the code manager 220 may facilitate retrieval or importing of executable code to be included in a code enabled media file generated by the code enabled media generator 110 of FIG. 2. In some examples, the code manager 220 facilitates generation (e.g., writing, compiling, etc.) of executable code to be included in code enabled media files. Accordingly, the code manager 220 may be used to add executable code to a code enabled media file composition.

The example code enabled media compiler 230 finalizes or generates a code enabled media file. Referring now to FIG. 3, an example code enabled media file 300 generated by the code enabled media compiler 230 is illustrated. The example code enabled media file 300 of FIG. 3 includes five tracks 301-305, including an image (track 301), an audio file (track 302), a subtitle (track 303), a video file (track 304), and executable code (track 305). The code enabled media compiler 230 of FIG. 2 may have received the media or metadata of tracks 301-304 from the media manager 210 and the executable code of track 305 from the code manager 220. The example code enabled media compiler 230 generates/compiles the code enabled media file 300 to include the executable code of track 305 such that when the code enabled media file 300 is presented, the executable code of track 305 will be executed at a corresponding time of the code enabled media file 300 (e.g., time T_{C}).

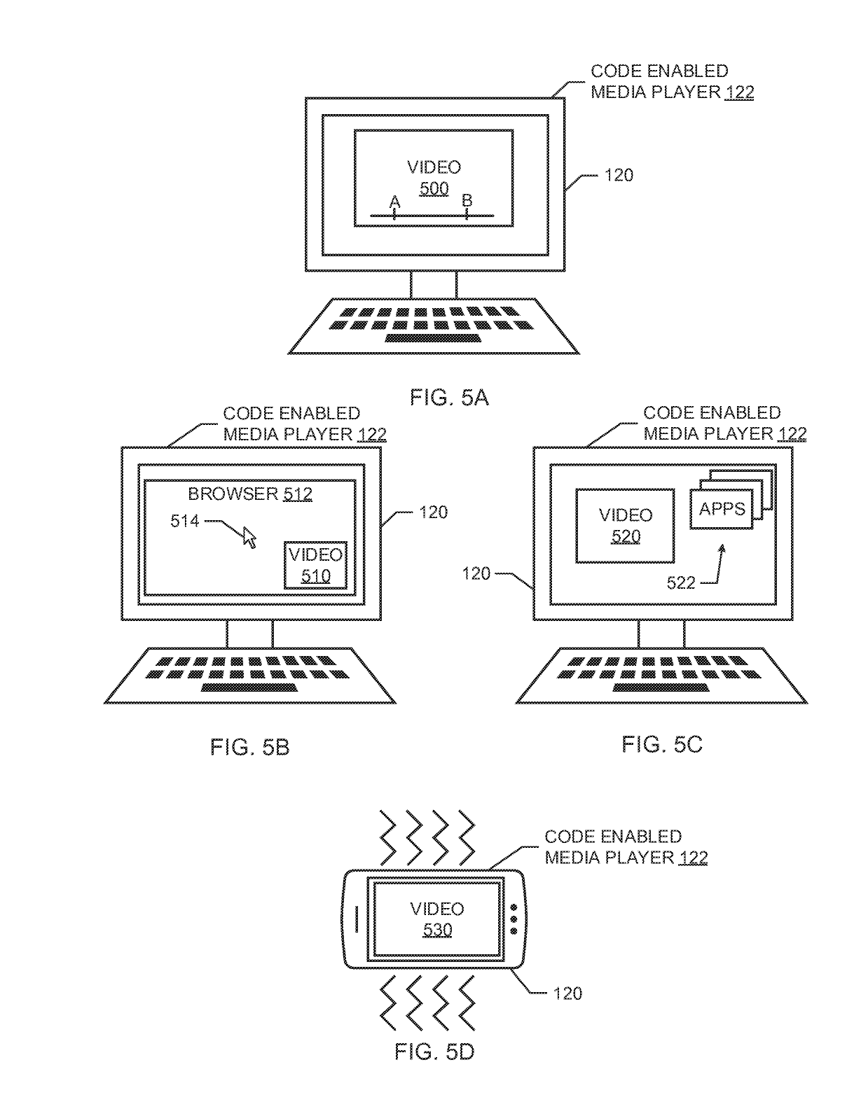

During presentation of the code enabled media file 300, each element of the tracks 301-305 is presented (e.g., via the display 130) at a corresponding time (e.g., T_{I} for the image of track 301, T_{A} for the audio of track 302. T_{S} for the subtitle of track 303, T_{V} for the video of track 304, and T_{C} for the executable code of track 305) along the time line T and lasts for a corresponding duration of time (as represented by the gray portion of the track). Presentation or execution of the elements of the media/metadata tracks 301-304 may be implemented by any suitable techniques (e.g., media player codecs, etc.). When executed during presentation of the code enabled media file 300, the executable code of track 305 may control playback of the code enabled media file 300 or a surrounding environment (e.g., an operating system, an application running alongside the media of the media file 300, etc.) of the presented code enabled media file 300. For example, when executed, the executable code of track 305 may instruct a media player (e.g., the code enabled media player 122) to replay a portion of the code enabled media file 300, jump to a particular time of the code enabled media file 300, or control setting(s) of a media player facilitating presentation of the code enabled media file 300 (e.g., quality, color, brightness, formatting, etc.). As another example, when executed or identified, the executable code of the track 305 or a media player detecting the executable code of track 305 may instruct an operating system of the host device 120 to execute the executable code of the track 305 to open or control a browser of the host device 120 (e.g., to search or navigate the Internet), to open or navigate an application (e.g., a word processor, a game, etc.) of the host device 120. Further examples of execution of the executable code are further disclosed below in connection with FIGS. 5A-5D.

While an example manner of implementing the code enabled media generator 110 of FIG. 1 is illustrated in FIG. 2, at least one of the elements, processes or devices illustrated in FIG. 2 may be combined, divided, re-arranged, omitted, eliminated or implemented in any other way. Further, the media manager 210, the code manager 220, the code enabled media compiler 230 or, more generally, the example code enabled media generator 110 of FIG. 2 may be implemented by hardware or any combination of hardware and executable instructions (e.g., software or firmware). Thus, for example, any of the media manager 210, the code manager 220, the code enabled media compiler 230 or, more generally, the example code enabled media generator 110 could be implemented by at least one of an analog or digital circuit, a logic circuit, a programmable processor, an application specific integrated circuit (ASIC), a programmable logic device (PLD) or a field programmable logic device (FPLD). When reading any of the apparatus or system claims of this patent to cover a purely software (i.e., executable instructions) or firmware implementation, at least one of the media manager 210, the code manager 220, or the code enabled media compiler 230 is/are hereby expressly defined to include a tangible computer readable storage device or storage disk such as a memory, a digital versatile disk (DVD), a compact disk (CD), a Bluray™ disk, etc. storing the executable instructions. Further still, the example code enabled media generator 110 of FIG. 2 may include at least one element, process, or device in addition to, or instead of, those illustrated in FIG. 2, or may include more than one of any or all of the illustrated elements, processes and devices.

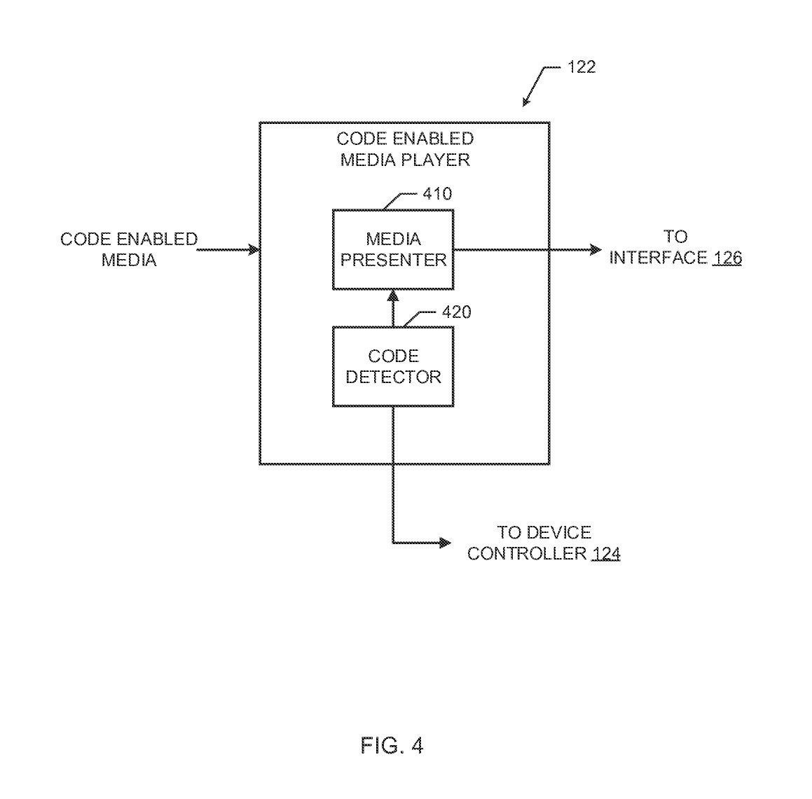

FIG. 4 is a block diagram of an example code enabled media player 122 that may be used to implement the code enabled media player 122 of FIG. 1 or facilitate presentation/execution of the example code enabled media file 300 of FIG. 3. The example code enabled media player 122 of FIG. 4 includes an example media presenter 410 and example code detector 420. The example media presenter 410 may be implemented by any suitable technique (e.g., a codec) to facilitate presentation of media (e.g., audio, video, images, text, etc., such as the media/metadata of tracks 301-304 of FIG. 3) of a code enabled media file (e.g., the code enabled media file 300). Accordingly, the example media presenter 410 provides media data or metadata to an interface (e.g., the interface 126) or an output device (e.g., a display, speakers, etc.) for presentation to the media.

The example code detector 420 detects code (e.g., the executable code of track 305) within a code enabled media file (e.g., the code enabled media file 300 of FIG. 3) and initiates execution of the code or executes the code. The example code detector 420 monitors for or identifies executable code within media files (e.g., the code enable media file 300). The example code detector 420 may support detection any suitable language (e.g., Javascript, Linux Shell, PowerShell, Batch files, etc.) and cause the host device 120 (e.g., via the device controller 124) to execute any type of identifiable code within code enabled media files. In some examples, the code detector 420 may locally execute the executable code within the code enabled media player 122. In some examples, the example code detector 420 may be implemented by a plug-in for a media player (e.g., the code enabled media player 122), an API, or by any other suitable executable instructions to update or adjust the media player. Accordingly, in such examples, an example media player that is unable to identify or execute code within media files may be updated with a plug-in including the code detector 420 of FIG. 4 to provide for identification or execution of the code.

The example code detector 420 of FIG. 4 detects a location of executable code within a media file. For example, the code detector 420 may determine that code is to be executed at particular times during playback of a media file. Accordingly, a particular timestamp (e.g., a point in time of the media) of media being played back via the code enabled media player 122 of FIG. 4 may be a trigger to cause the code detector 420 to initiate execution of executable code within a code enabled media file (e.g., by sending the executable code or instructions to a device controller 124 to execute the executable code) or execute the executable code. Furthermore, a duration of time corresponding to execution of the code may additionally be monitored. For example, the code detector 420 may cease execution of executable code after a designated period of time that the executable code is to be executed during playback of a code enabled media file (e.g., corresponding to a length of time indicated in a track of the media file including the executable code).

As illustrated in the example of FIG. 4, the code detector 420 may communicate with the media presenter 410 to control playback of a code enabled media file or a device controller (e.g., the device controller 124 of FIG. 1) to control an environment (e.g., an operating system controlled by the device controller 124) of the media playback. Accordingly, the example code detector 420 may control or cause control of the code enabled media player 122 or an environment of the code enabled media player 122 based on executable code within a code enabled media file. For example, the code detector 420 may instruct the media presenter 410 to alter presentation settings (e.g., quality, color, brightness, aspect ratio, format, etc.) of the code enabled media player 122 via an API. In another example, the code detector 420 may send the executable code or instructions based on the executed executable code to the device controller 124 to control an operating system of the host device 120 to open, navigate, close, etc. applications, browsers, folders, documents, etc. on the host device 120. In such an example, an API of the code enabled media player 122 may be used to play back media in accordance with the device controller 124 controlling a target (e.g., a browser, application, etc.) by executing the executable code associated with the media.

While an example manner of implementing the code enabled media player 122 of FIG. 1 is illustrated in FIG. 4, at least one of the elements, processes or devices illustrated in FIG. 4 may be combined, divided, re-arranged, omitted, eliminated or implemented in any other way. Further, the media presenter 410, the code detector 420, or, more generally, the example code enabled media player 122 of FIG. 4 may be implemented by hardware or any combination of hardware and executable instructions (e.g., software or firmware). Thus, for example, any of media presenter 410, the code detector 420, or, more generally, the example code enabled media player 122 could be implemented by at least one of an analog or digital circuit, a logic circuit, a programmable processor, an application specific integrated circuit (ASIC), a programmable logic device (PLD) or a field programmable logic device (FPLD). When reading any of the apparatus or system claims of this patent to cover a purely software or firmware implementation, at least one of the media presenter 410 or code detector 420 is/are hereby expressly defined to include a tangible computer readable storage device or storage disk such as a memory, a digital versatile disk (DVD), a compact disk (CD), a Blu-ray™ disk, etc. storing the executable instructions. Further still, the example code enabled media player 122 of FIG. 4 may include at least one element, process, or device in addition to, or instead of, those illustrated in FIG. 4, or may include more than one of any or all of the illustrated elements, processes and devices.

FIGS. 5A-5D illustrate example executions of a code enabled media file, such as the code enabled media file of FIG. 3, when accessed via the code enabled media player of FIG. 1 or 4. Each of the illustrated examples of FIGS. 5A-5D includes an example host device 120 including a code enabled media player 122, which may be implemented by the code enabled media player 122 of FIG. 1 or 4. The example code enabled media players 122 of FIGS. 5A-5D are presenting videos 500, 510, 520, 530, respectively, from media files that each include executable code to control code enabled media players 122 or environments/outputs of the host devices 120.

In the illustrated example of FIG. 5A, the code enabled media player 122 facilitates presentation of a video 500. A code detector 420 of the code enabled media player 122 may execute code or cause execution of code within a media file associated with the video 500 at a designated point in time of the video 500 to cause playback of the video to jump from point A to point B in FIG. 5A. For example, integrated script within the code associated with the video 500 of FIG. 5A may interact with the code enabled media player 122 via an API to cause the jump from point A to point B of the video 500.

In the illustrated example of FIG. 5B, the code enabled media player 122 facilitates presentation of a video 510 and a browser 512. In the illustrated example, a code detector 420 of the code enabled media player 122 may execute code or instruct a host device 120 to execute code to open, control, close, or navigate the browser 512 of the host device 120 of FIG. 5B. For example, the executed code may cause the browser 512 to navigate to a particular web site, web page, uniform resource locator (URL), etc. while presenting the video 510. As a more specific example, executable code included within a code enabled media file of the video 510 that is describing a particular company may cause the host device 120 of FIG. 5B to open the browser 512 to a website associated with that particular company. In another specific example, the video 510 and executable code associated with the video may include a tutorial for the user on how to navigate or perform tasks (e.g., fill out particular forms, register Information, access information, etc.) on a website of the browser 512. In some examples, executable code may cause control of a cursor 514 of FIG. B to navigate the browser 512 or an operating system of the host device 120. More specifically, the example video 510 may be a help video to configure an operating system of the host device 120, and the executable code may facilitate configuration or provide instructions for configuration of the operating system (e.g., by retrieving or showing a user how to retrieve an update via the browser 512).

In the illustrated example of FIG. 5C, the code enabled media player 122 facilitates presentation of a video 520 and applications 522. In the illustrated example, a code detector 420 of the code enabled media player 122 may execute code or instruct the host device 120 to execute code to open, control, close, or navigate the applications 522 within an operating system of the host device 120 of FIG. 5C. For example, the code, executed at a particular time while presenting the video 520, may cause at least one of the applications 522 to open, close, perform operations of the applications 122, etc. As a more specific example, executable code included within a code enabled media file of the video 520 that is presenting a tutorial on the applications 522 may cause the applications 522 to perform certain operations (e.g., open particular menus, change settings, perform tasks, etc.) on the host device 120 of FIG. 5C. Furthermore, in such an example or in other examples, the executed code may provide user exercises within the applications 522 and the video 520 may be played back in response to a users interaction with the applications 522.

In the illustrated example of FIG. 5D, the code enabled media player 122 facilitates presentation of a video 530 on the host device 120, which may be a smartphone or tablet including a vibration mechanism. In the illustrated example, a code detector 420 of the code enabled media player 122 may execute code to cause the vibration mechanism to activate and vibrate the host device 120 at a particular time illustrated in FIG. 5D. For example, executable code may cause the vibration mechanism to vibrate the host device 120 when the video 530 is presenting an explosion. In such an example, the code detector 420 executes the code at a time corresponding to the explosion in the video 530.

In the illustrated example of FIGS. 5A-5D, the example executable code may be specific or adaptable to each type of the host devices 120 (e.g., a computer, a smartphone, a tablet computer, etc.) or platform (e.g., operating system) of each of the host devices 120 (e.g., Microsoft™ Windows™, Linux™, Apple OS™, iOS™, Android™, etc.). Accordingly, the executable code may be configured to identify the particular platform of host devices 120 such that the host devices 120 may execute the executable code to perform the intended operations. For example, in FIG. 5D, the executable code may determine that the host device 120 is a smartphone that includes a vibration mechanism, and therefore the executable code may be executed by the host device 120 to cause vibration of the host device 120. However, if such executed code were executed on a non-smartphone device without a vibration mechanism, the executed code may not have been executed to control a vibration mechanism, or the executed code may have been executed but vibration would not occur. Accordingly, in some examples, the executable code may include directives to direct parts of an executable code to be executed for corresponding platforms of the host devices 120.

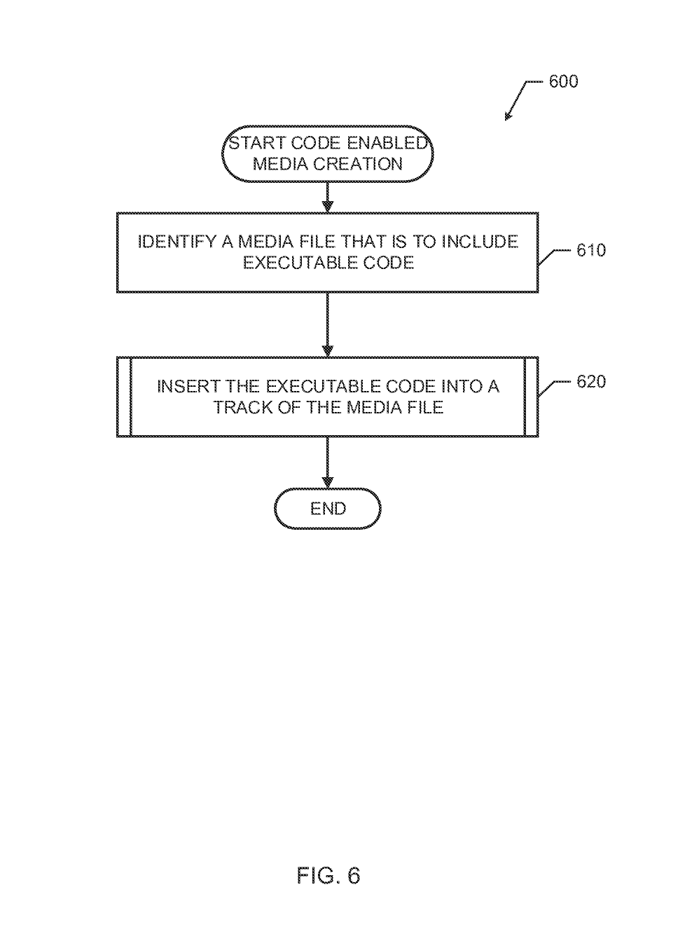

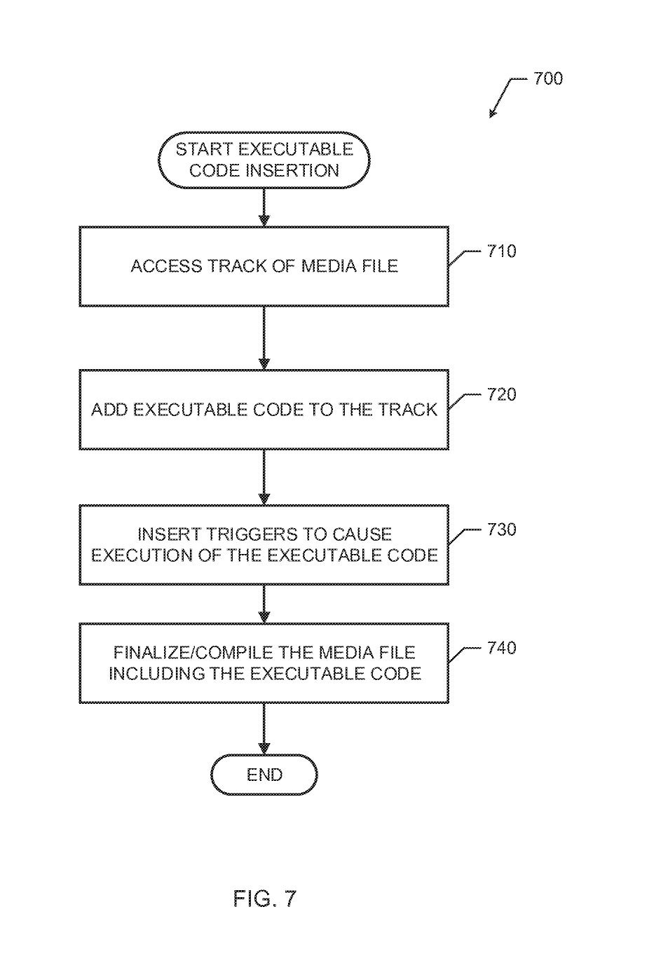

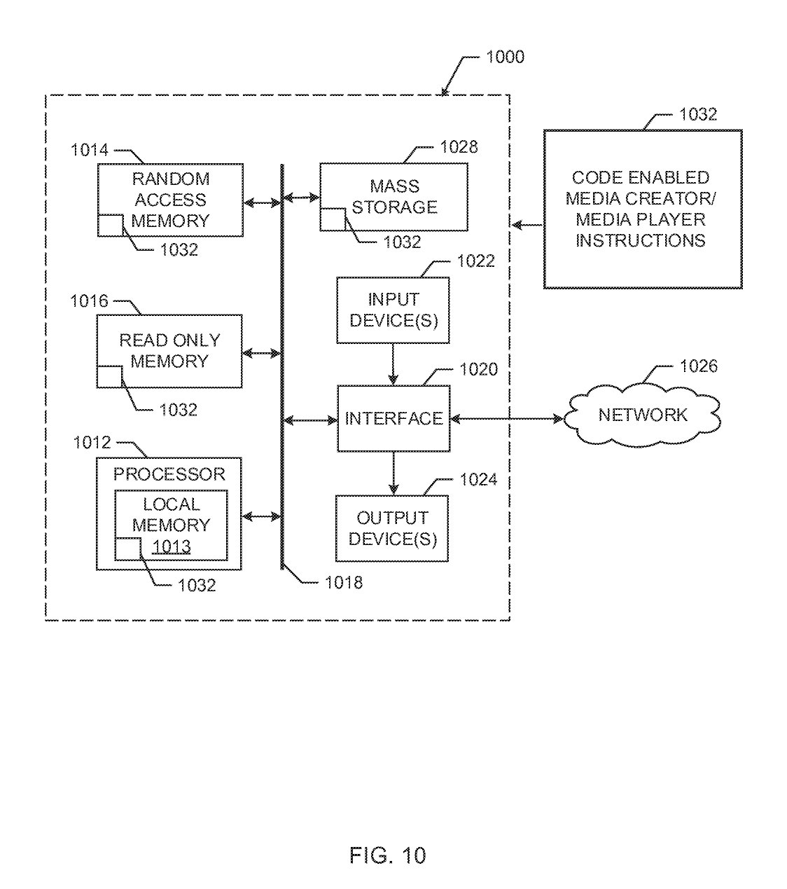

Flowcharts representative of example machine readable instructions for implementing the code enabled media generator 110 of FIG. 2 are shown in FIG. 6 or 7. In this example, the machine readable instructions comprise a program/process for execution by a processor such as the processor 1012 shown in the example processor platform 1000 discussed below in connection with FIG. 10. The program/process may be embodied in executable instructions (e.g., software) stored on a tangible computer readable storage medium such as a CD-ROM, a floppy disk, a hard drive, a digital versatile disk (DVD), a Blu-ray disk, or a memory associated with the processor 1012, but the entire program/process or parts thereof could alternatively be executed by a device other than the processor 1012 or embodied in firmware or dedicated hardware. Further, although the example program/process is described with reference to the flowcharts illustrated in FIG. 6 or 7, many other methods of implementing the example code enabled media generator 110 may alternatively be used. For example, the order of execution of the blocks may be changed, or some of the blocks described may be changed, eliminated, or combined.

The process 600 of FIG. 6 begins with an initiation of the code enabled media generator 110 (e.g., upon startup, upon instructions from a user, upon startup of a device implementing the code enabled media generator 110 (e.g., the host device 120), etc.). At block 610, the code enabled media generator 110 identifies a media file that is to include executable code. For example, the media manager 210 may retrieve a media file (e.g., in response to user instructions) from a database. At block 620, the code manager 220 may insert the executable code into a track of the media file. Accordingly, the process 600 of FIG. 6 provides a media file including media to be presented and executable code that is to be executed. After block 620, the process 600 of FIG. 6 ends.

FIG. 7 is a flowchart representative of an example process 700 that may be executed to implement the block 620 of FIG. 6. The example process 700 may be executed to implement the code manager 220 or code enabled media compiler 230 of FIG. 2 to insert executable code into a media file. The process 700 of FIG. 7 begins with an initiation of the code enabled media generator 110. At block 710, the code manager 220 accesses a track of a media file (e.g., track 305 of the media file 300 of FIG. 3). For example, the code manager 220 may find a track of a media file that has capacity or availability to include executable code. In some examples, at block 710, the code manager 220 may create a new track for the media file to include the executable code.

At block 720 of the example process 700 of FIG. 7, the code manager 220 adds the executable code to the track. For example, the code manager 220 writes or copies the executable code into the media file. At block 730, the code enabled media compiler 230 inserts triggers to cause execution of the executable code. For example, the code enabled media compiler 230 may place triggers within the media file to cause the execution of the executable code at designated times (e.g., timestamps) of media within the media file, such that when the media is played back, at the designated times, the executable code is to be executed. At block 740 of FIG. 7, the code enabled media compiler 230 finalizes/compiles the media file to include the executable code. Accordingly, in block 740, the media file is complete such that upon play back of media within the media file, executable code within the media file may be executed in accordance with or complementary to the media playback. After block 740, the process 700 ends.

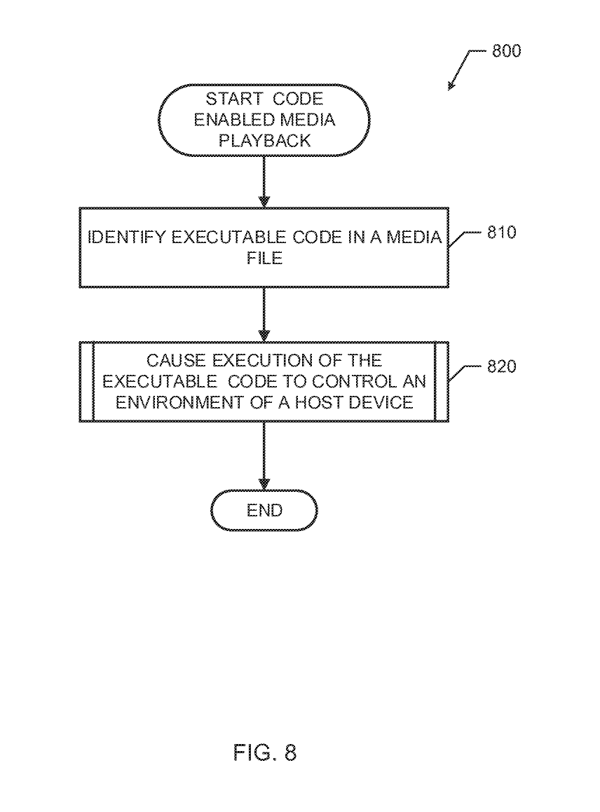

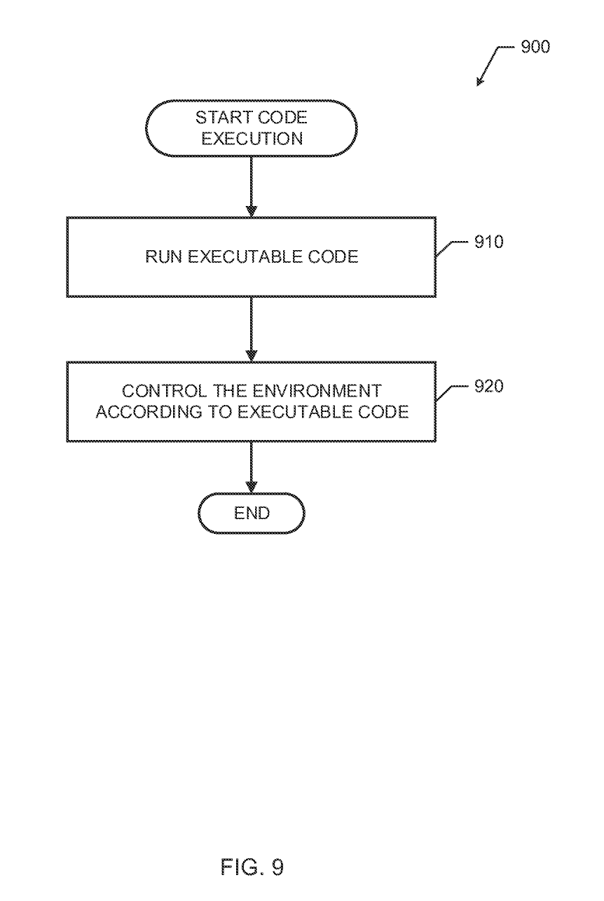

Flowcharts representative of example machine readable instructions for implementing the code enabled media player 122 of FIG. 4 are shown in FIG. 8 or 9. In this example, the machine readable instructions comprise a program/process for execution by a processor such as the processor 1012 shown in the example processor platform 1000 discussed below in connection with FIG. 10. The program/process may be embodied in executable instructions (e.g., software) stored on a tangible computer readable storage medium such as a CD-ROM, a floppy disk, a hard drive, a digital versatile disk (DVD), a Blu-ray disk, or a memory associated with the processor 1012, but the entire program/process or parts thereof could alternatively be executed by a device other than the processor 1012 or embodied in firmware or dedicated hardware. Further, although the example program is described with reference to the flowcharts illustrated in FIG. 8 or 9, many other methods of implementing the example code enabled media player 122 may alternatively be used. For example, the order of execution of the blocks may be changed, or some of the blocks described may be changed, eliminated, or combined.

The process 800 of FIG. 8 begins with an initiation of the code enabled media player 122 (e.g., upon startup, upon instructions from a user, upon startup of a device implementing the code enabled media player 122 (e.g., the host device 120), etc.). At block 810, the code detector 420 identifies executable code in a media file (e.g., executable code that was inserted into a media file via the code enabled media generator 110 of FIG. 2). At block 820, the code detector 420 causes execution of the executable code to control an environment of the host device 120. For example, the executable code of block 820 may be executed by the code detector 420 to control the code enabled media player 122 or an operating system of the host device 120. In another example, the code detector 420 may send instructions or the executable code to the host device 120 to cause the host device 120 to execute the executable code to control the code enabled media player 122 or an environment of the host device 120. The example executable code of FIG. 8 may be executed to control playback of media in the media file, or adjust settings (e.g., display quality, color settings, format settings, size settings, etc.) of the code enabled media player 122. Additionally or alternatively, the executable code of FIG. 8 may be executed to open, close, navigate, or control browsers, applications, peripheral devices (e.g., vibration mechanisms, light emitters (e.g., LEDs, flashes, cameras, etc.), etc. of the host device 120.

FIG. 9 is a flowchart representative of an example process 900 that may be executed to implement the block 820 of FIG. 8. The example process 900 may be executed to implement the code detector 420 of FIG. 4 to cause execution of the executable code of a media file. The process 900 of FIG. 9 begins with an initiation of the code enabled media player 122 or the code detector 420 of FIG. 2. At block 910, the code detector 420 runs the executable code or instructs the host device 120 (e.g., via the device controller 124) to run the executable code. In some examples, prior to block 910, the code detector 420 may analyze the executable code or identify a language or directives of the executable code to confirm compatibility with the host device 120 or code enabled media player 122. At block 920, the code detector 420 or host device 120 (e.g., via the device controller 124) controls an environment (e.g., the code enabled media player 122, the interface 126, an operating system, etc.) according to the executable code. In some examples, the executable code or portions of the executable code may be executed within a targeted environment of the executable code (e.g., the code enabled media player 122, a browser, an application, etc.). After block 920, the process 900 ends.

As mentioned above, the example processes of FIG. 6 or 7 or the example processes of FIG. 8 or 9 may be implemented using coded instructions (e.g., computer or machine readable instructions) stored on a tangible computer readable storage medium such as a hard disk drive, a flash memory, a read-only memory (ROM), a compact disk (CD), a digital versatile disk (DVD), a cache, a random-access memory (RAM) or any other storage device or storage disk in which information is stored for any duration (e.g., for extended time periods, permanently, for brief instances, for temporarily buffering, or for caching of the information). As used herein, the term tangible computer readable storage medium is expressly defined to include any type of computer readable storage device or storage disk and to exclude propagating signals and to exclude transmission media. As used herein, “tangible computer readable storage medium” and “tangible machine readable storage medium” are used interchangeably. Additionally or alternatively, the example processes of FIG. 6 or 7 or the example processes of FIG. 8 or 9 may be implemented using coded instructions (e.g., computer or machine readable instructions) stored on a non-transitory computer or machine readable medium such as a hard disk drive, a flash memory, a read-only memory, a compact disk, a digital versatile disk, a cache, a random-access memory or any other storage device or storage disk in which information is stored for any duration (e.g., for extended time periods, permanently, for brief instances, for temporarily buffering, or for caching of the information). As used herein, the term non-transitory computer readable medium is expressly defined to include any type of computer readable storage device or storage disk and to exclude propagating signals and to exclude transmission media. As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, the term “or” may mean “and/or” such that the term “or” is not considered to be an “exclusive or” unless otherwise indicated.

FIG. 10 is a block diagram of an example processor platform 1000 capable of executing the instructions of FIG. 6 or 7 or the instructions of FIG. 8 or 9 to implement the code enabled media generator 110 of FIG. 2 or the code enabled media player 122 of FIG. 4, respectively. The example processor platform 1000 may be or may be included in any type of apparatus, such as a server, a personal computer, a mobile device (e.g., a cell phone, a smart phone, a tablet, etc.), a personal digital assistant (FDA), an Internet appliance, a DVD player, a CD player, a digital video recorder, a Blu-ray player, a gaming console, a personal video recorder, a set top box, or any other type of computing device.

The processor platform 1000 of the illustrated example of FIG. 10 includes a processor 1012. The processor 1012 of the illustrated example is hardware. For example, the processor 1012 can be implemented by at least one integrated circuit, logic circuit, microprocessor or controller from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) or any other type of random access memory device. The non-volatile memory 1016 may be implemented by flash memory or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), or a peripheral component interconnect (PCI) express interface.

In the illustrated example, at least one input device 1022 is connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint or a voice recognition system.

At least one output device 1024 is also connected to the interface circuit 1020 of the illustrated example. The output device(s) 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer or speakers). The output device(s) 1024 may be used to implement the output device 130 of FIG. 1. The interface circuit 1020 of the illustrated example, thus, may include a graphics driver card, a graphics driver chip or a graphics driver processor. The example interface circuit 1020 may be used to implement the interface 126 of FIG. 1.

The interface circuit 1020 of the illustrated example also includes a communication device such as a transmitter, a receiver, a transceiver, a modern or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes at least one mass storage device 1028 for storing executable instructions (e.g., software) or data. Examples of such mass storage device(s) 1028 include floppy disk drives, hard drive disks, compact disk drives, Blu-ray disk drives, RAID systems, and digital versatile disk (DVD) drives.

The coded instructions 1032 of FIG. 6, 7, 8, or 9 may be stored in the mass storage device 1028, in the local memory 1013 in the volatile memory 1014, in the non-volatile memory 1016, or on a removable tangible computer readable storage medium such as a CD or DVD.

From the foregoing, it will be appreciated that examples disclosed herein provide for executable code to be included within a media file or execution of executable code within a media file for control of an environment of a host device playing back media of the media file. Accordingly, a user's experience of viewing or interacting with media may be enhanced by including executable code to increase/enable user interaction with an environment of the media. In such examples, viewing of media may be complemented with performing tasks or viewing control of associated or corresponding applications, web pages, browsers, etc.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
identifying, via a processor, a media file that is to include executable code; and inserting, via the processor, the executable code into a track of the media file, the executable code to be executed upon playback of media within the media file and, when executed, the executable code is to cause control of an environment of the host device playing back the media.

2. The method as defined in claim 1, wherein inserting the executable code comprises:
identifying the track of the media file;
adding the executable code into the track; and
inserting triggers to cause execution of the executable code upon the playback of the media.

3. The method as defined in claim 1, wherein the executable code is to be executed to control the host device in response to a trigger caused by playing back the media file.

4. The method as defined in claim 3, wherein the trigger comprises a timestamp associated with the media.

5. The method as defined in claim 1, further comprising editing the executable code after being inserted in the track of the media file.

6. The method as defined in claim 1, further comprising compiling the media file to include the media and the executable code.

7. A method comprising:
identifying executable code within the media file, the media file comprising media being played back by a host device; and
causing, via a processor, execution of the executable code to control an environment of the host device.

8. The method as defined in claim 7, wherein causing execution of the executable code comprises executing the executable code.

9. The method as defined in claim 7, wherein causing execution of the executable code comprises instructing the host device to execute the executable code.

10. The method as defined in claim 8, wherein the environment comprises a media player of the host device and causing execution of the executable code causes the media player to at least one of control play back of the media or adjust settings of the media player.

11. The method as defined in claim 8, wherein the environment is an operating system of the host device.

12. The method as defined in claim 1, wherein causing execution of the executable code causes the operating system of the host device to control at least one of a browser of the host device, an application of the host device, or a peripheral of the host device.

13. A non-transitory computer readable storage medium comprising instructions that, when executed, cause a machine to at least:
detect executable code within a media file comprising media being presented on a host device; and
execute the executable code to control an environment of the host device.

14. The non-transitory computer readable storage medium of claim 13, comprising instructions that, when executed, further cause the machine to:
analyze the media file, the media file comprising media being played back on the host device;
identify a track comprising the executable code; and
cause playback of the media on the host device.

15. The non-transitory computer readable storage medium of claim 13, comprising instructions that, when executed, further cause the machine to:
send instructions to the environment of the host device to control the host device, wherein the environment comprises at least one of a media player of the host device or an operating system of the host device.

16. The non-transitory computer readable storage medium of claim 13, comprising instructions that, when executed, further cause the machine to:
identify a trigger of the media file to cause the instructions to execute the executable code.

17. The non-transitory computer readable storage medium of claim 16 wherein the trigger comprises a timestamp of media associated with the media file, the media being played back by the host device.
